(19) United States
(12) Patent Application Publication
(10) Pub. No.: US 2007/0211800 A1
(43) Pub. Date: Sep. 13, 2007

(54) Method and Apparatus for Frame Rate Up Conversion with Multiple Reference Frames and Variable Block Sizes

(75) Inventors: Fang Shi, San Diego, CA (US); Vijayalakshmi R. Raveendran, San Diego, CA (US)

Correspondence Address: QUALCOMM INCORPORATED, 5775 MOREHOUSE DR., SAN DIEGO, CA, 92121, US

(73) Assignee: QUALCOMM INCORPORATED, San Diego, CA (US)

(21) Appl. No.: 11/697,282

(22) Filed: Apr. 5, 2007

Related U.S. Application Data
(63) Continuation of application No. 11/186,682, filed on Jul. 20, 2005, now abandoned.
(60) Provisional application No. 60/589,990, filed on Jul. 20, 2004.

(51) Int. Cl. H04N 7/12

(52) U.S. Cl. 375/240.16

(57) ABSTRACT

A method for creating an interpolated video frame using a current video frame, and a plurality of previous video frames is presented. The method includes creating a set of extrapolated motion vectors from at least one reference video frame in the plurality of previous video frames; performing an adaptive motion estimation using the extrapolated motion vectors and a class type of each extrapolated motion vector; deciding on a motion compensated interpolation mode; and, creating a set of motion compensated motion vectors based on the motion compensated interpolation mode decision. An apparatus for performing the method is also disclosed.

### CLAIM OF PRIORITY

The present application for patent is a continuation of, and claims the benefit of priority from, U.S. patent application Ser. No. 11/186,682 entitled “Method and Apparatus for Frame Rate Up Conversion with Multiple Reference Frames and Variable Block Sizes,” filed Jul. 20, 2005, which claims the benefit of priority from U.S. Provisional Patent Application No. 60/589,990 entitled “Method and Apparatus for Frame Rate up Conversion,” filed Jul. 20, 2004, both of which are assigned to the assignee hereof and both are fully incorporated herein by reference for all purposes

### REFERENCE TO CO-PENDING APPLICATIONS FOR PATENT

The present application for patent is related to co-pending U.S. patent application Ser. No. 11/122,678 entitled “Method and Apparatus for Motion Compensated Frame Rate up Conversion for Block-Based Low Bit-Rate Video” filed May 4, 2005, which is assigned to the assignee hereof and fully incorporated herein by reference for all purposes.

### BACKGROUND

1. Field

The embodiments described herein generally relate to multimedia data processing, and more particularly, to a method and apparatus for frame rate up conversion (FRUC) with multiple reference frames and variable block sizes.

2. Background

Low bit rate video compression is very important in many multimedia applications such as wireless video streaming and video telephony, due to the limited bandwidth resources and the variability of available bandwidth. Bandwidth adaptation video coding at low bit-rate can be accomplished by reducing the temporal resolution. In other words, instead of compressing and sending a thirty (30) frame per second (fps) bit-stream, the temporal resolution can be halved to 15 fps to reduce the transmission bit-rate. However, the consequence of reducing temporal resolution is the introduction of temporal domain artifacts such as motion jerkiness that significantly degrades the visual quality of the decoded video.

To display the full frame rate at the receiver side, a recovery mechanism, called frame rate up conversion (FRUC), is needed to re-generate the skipped frames and to reduce temporal artifacts. Generally, FRUC is the process of video interpolation at the video decoder to increase the perceived frame rate of the reconstructed video.

Many FRUC algorithms have been proposed, which can be classified into two categories. The first category interpolates the missing frame by using a combination of received video frames without taking the object motion into account. Frame repetition and frame averaging methods fit into this class. The drawbacks of these methods include the production of motion jerkiness, “ghost” images and blurring of moving objects when there is motion involved. The second category is more advanced, as compared to the first category, and utilizes the transmitted motion information, the so-called motion compensated (frame) interpolation (MCI).

As illustrated in prior art FIG. 2, in MCI a missing frame 208 is interpolated based on a reconstructed current frame 202, a stored previous frame 204, and a set of transmitted motion vectors 206. The reconstructed current frame 202 is composed of a set of non-overlapped blocks 250, 252, 254 and 256 associated with the set of transmitted motion vectors 206 pointing to corresponding blocks in the stored previous frame 204. Thus, the interpolated frame 208 can be constructed in either a linear combination of corresponding pixels in current and previous frames; or nonlinear operation such as a median operation.

Although block-based MCI offers some advantages, it also introduces unwanted areas such as overlapped (multiple motion trajectories pass through this area) and hole (no motion trajectory passes through this area) regions in interpolated frames. As illustrated in FIG. 3, an interpolated frame 302 contains an overlapped area 306 and a hole area 304. The main causes for these two types of unwanted areas are:
1. moving objects are not under a rigid translational motion model;
2. the transmitted motion vectors used in the MCI may not point to the true motion trajectories due to the block-based fast motion search algorithms utilized in the encoder side; and,
3. the covered and uncovered background in the current frame and previous frames.

The interpolation of overlapped and hole regions is a major technical challenge in conventional block-based motion compensated approaches. Median blurring and spatial interpolation techniques have been proposed to fill these overlapped and hole regions. However, the drawbacks of these methods are the introduction of the blurring and blocking artifacts, and also an increase in the complexity of interpolation operations.

Accordingly, there is a need to overcome the issues noted above.

### SUMMARY

The methods and apparatus provide a flexible system for implementing various algorithms applied to Frame Rate Up Conversion (FRUC). For example, in one embodiment, the algorithms provides support for multiple reference frames, and content adaptive mode decision variations to FRUC.

In one embodiment, a method for creating an interpolated video frame using a current video frame and a plurality of previous video frames includes creating a set of extrapolated motion vectors from at least one reference video frame in the plurality of previous video frames, then performing an adaptive motion estimation using the extrapolated motion vectors and a class type of each extrapolated motion vector. The method also includes deciding on a motion compensated interpolation mode, and, creating a set of motion compensated motion vectors based on the motion compensated interpolation mode decision.

In another embodiment, a computer readable medium having instructions stored thereon, the stored instructions, when executed by a processor, cause the processor to perform a method for creating an interpolated video frame using a current video frame and a plurality of previous video frames. The method including creating an interpolated video frame using a current video frame and a plurality of previous video frames includes creating a set of extrapolated motion vectors from at least one reference video frame in the plurality of previous video frames, then performing an adaptive motion estimation using the extrapolated motion vectors and a class type of each extrapolated motion vector. The method also includes deciding on a motion compensated interpolation mode, and, creating a set of motion compensated motion vectors based on the motion compensated interpolation mode decision.

In yet another embodiment, a video frame processor for creating an interpolated video frame using a current video frame and a plurality of previous video frames includes means for creating a set of extrapolated motion vectors from at least one reference video frame in the plurality of previous video frames; and means for performing an adaptive motion estimation using the extrapolated motion vectors and a class type of each extrapolated motion vector. The video frame processor also includes means for deciding on a motion compensated interpolation mode, and, means for creating a set of motion compensated motion vectors based on the motion compensated interpolation mode decision.

Other objects, features and advantages of the various embodiments will become apparent to those skilled in the art from the following detailed description. It is to be understood, however, that the detailed description and specific examples, while indicating various embodiments, are given by way of illustration and not limitation. Many changes and modifications within the scope of the embodiments may be made without departing from the spirit thereof, and the embodiments include all such modifications.

### BRIEF DESCRIPTION OF THE DRAWINGS

The embodiments described herein may be more readily understood by referring to the accompanying drawings in which:

FIG. 1 is a block diagram of a Frame Rate Up Conversion (FRUC) system configured in accordance with one embodiment.

FIG. 2 is a figure illustrating the construction of an interpolated frame using motion compensated frame interpolation (MCI);

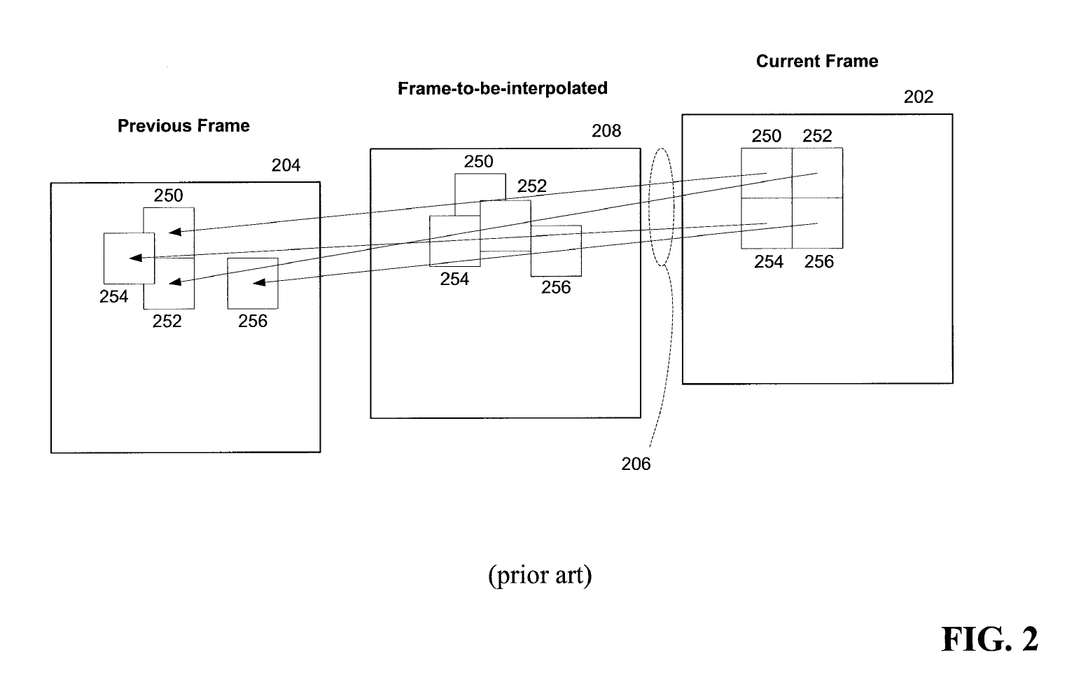

FIG. 3 is a figure illustrating overlapping and hole areas that may be encountered in an interpolated frame during MCI;

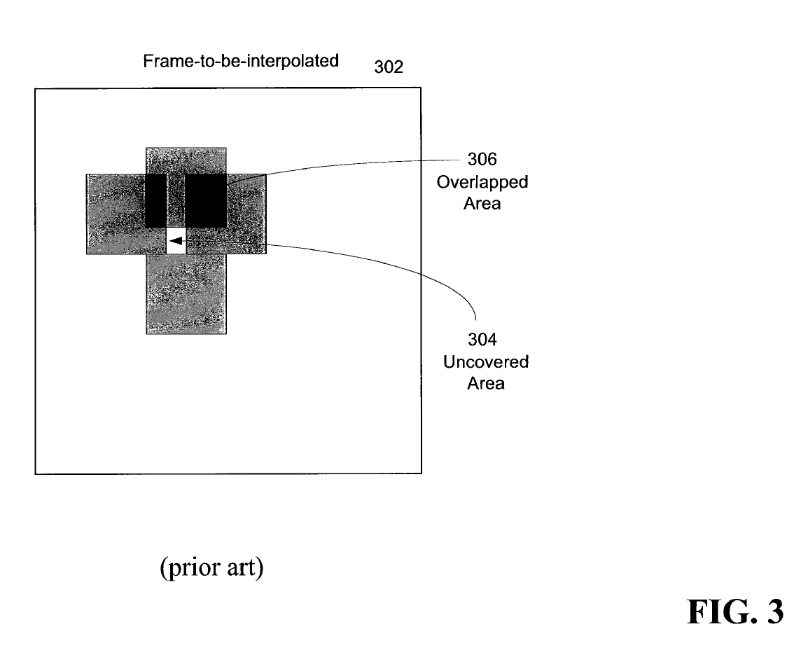

FIG. 4 is a figure illustrating the various classes assigned to the graphic elements inside a video frame;

FIG. 5 is a figure illustrating vector extrapolation for a single reference frame, linear motion model;

FIG. 6 is a figure illustrating vector extrapolation for a single reference frame, motion acceleration, model;

FIG. 7 is a figure illustrating vector extrapolation for a multiple reference frame, linear motion model with motion vector extrapolation;

FIG. 8 is a figure illustrating vector extrapolation for a multiple reference frame, non-linear motion model with motion vector extrapolation;

FIG. 9 is a flow diagram of an adaptive motion estimation decision process in the FRUC system that does not use motion vector extrapolation;

FIG. 10 is a flow diagram of an adaptive motion estimation decision process in the FRUC system that uses motion vector extrapolation; and,

FIG. 11 is a flow diagram of a mode decision process performed after a motion estimation process in the FRUC system.

FIG. 12 is a block diagram of an access terminal and an access point of a wireless system.

Like numerals refer to like parts throughout the several views of the drawings.

### DETAILED DESCRIPTION

The methods and apparatus described herein provide a flexible system for implementing various algorithms applied to Frame Rate Up Conversion (FRUC). For example, in one embodiment, the system provides for multiple reference frames in the FRUC process. In another embodiment, the system provides for content adaptive mode decision in the FRUC process. The FRUC system described herein can be categorized in the family of motion compensated interpolation (MCI) FRUC systems that utilizes the transmitted motion vector information to construct one or more interpolated frames.

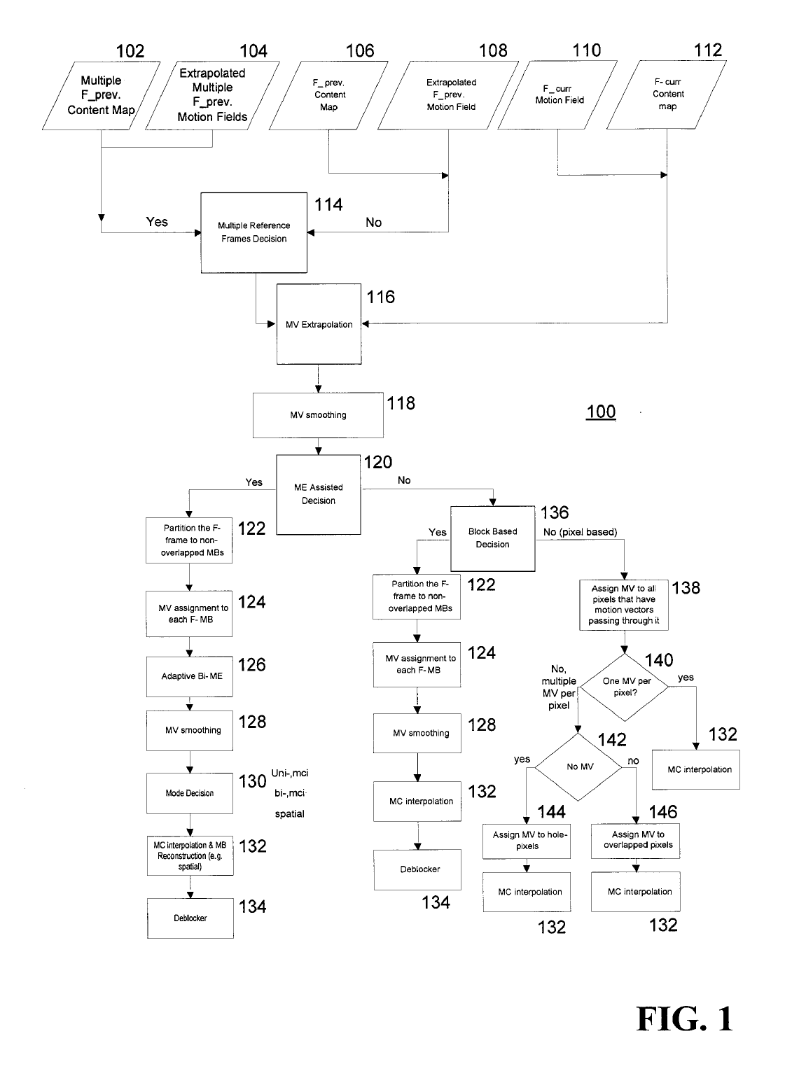

FIG. 1 is a block diagram of a FRUC system 100 for implementing the operations involved in the FRUC process, as configured in accordance with one embodiment. The components shown in FIG. 1 correspond to specific modules in a FRUC system that may be implemented using one or more software algorithms. The operation of the algorithms is described at a high-level with sufficient detail to allow those of ordinary skill in the art to implement them using a combination of hardware and software approaches. For example, the components described herein may be implemented as software executed on a general-purpose processor; as “hardwired” circuitry in an Application Specific Integrated Circuit (ASIC); or any combination thereof. It should be noted that various other approaches to the implementation of the modules described herein may be employed and should be within the realm of those of ordinary skill of the art who practice in the vast field of image and video processing.

Further, the inventive concepts described herein may be used in decoder/encoder systems that are compliant with H26x-standards as promulgated by the International Telecommunications Union, Telecommunications Standardization Sector (ITU-T); or with MPEGx-standards as promulgated by the Moving Picture Experts Group, a working group of the International Standardization Organization/International Electrotechnical Commission, Joint Technical Committee 1 (ISO/IEC JTC1). The ITU-T video coding standards are called recommendations, and they are denoted with H.26x (H.261, H.262, H.263 and H.264). The ISO/IEC standards are denoted with MPEG-x (MPEG-1, MPEG-2 and MPEG-4). For example, multiple reference frames and variable block size are special features required for the H264 standard. In other embodiments, the decoder/encoder systems may be proprietary.

In one embodiment, the system 100 may be configured based on different complexity requirements. For example, a high complexity configuration may include multiple reference frames; variable block sizes; previous reference frame motion vector extrapolation with motion acceleration models; and, motion estimation assisted double motion field smoothing. In contrast, a low complexity configuration may only include a single reference frame; fixed block sizes; and MCI with motion vector field smoothing. Other configurations are also valid for different application targets.

The system 100 receives input using a plurality of data storage units that contain information about the video frames used in the processing of the video stream, including a multiple previous frames content maps storage unit 102; a multiple previous frames extrapolated motion fields storage unit 104; a single previous frame content map storage unit 106; and a single previous frame extrapolated motion field storage unit 108. The motion vector assignment system 100 also includes a current frame motion field storage unit 110 and a current frame content map storage unit 112. A multiple reference frame controller module 114 will couple the appropriate storage units to the next stage of input, which is a motion vector extrapolation controller module 116 that controls the input going into a motion vector smoothing module 118. Thus, the input motion vectors in the system 100 may be created from the current decoded frame, or may be created from both the current frame and the previous decoded frame. The other input in the system 100 is the side-band information from the decoded frame data, which may include, but is not limited to, the region of interests, variation of texture information, and variation of luminance background value. The information may provide guidance for motion vector classification and adaptive smoothing algorithms.

Although the figure illustrates the use of two different sets of storage units for storing content maps and motion fields—one set for where multiple reference frames are used (i.e., the multiple previous frames content maps storage unit 102 and the multiple previous frames extrapolated motion fields storage unit 104) and another for where a single reference frame is used (i.e., the single previous frame content maps storage unit 106 and the single previous frame extrapolated motion field storage unit 108), it should be noted that other configurations are possible. For example, the functionality of the two different content map storage units may be combined such that one storage unit for storing content maps may be used to store either content maps for multiple previous frames or a single content map for a single previous frame. Further, the storage units may also store data for the current frame as well.

Based on the received video stream metadata (i.e., transmitted motion vectors) and the decoded data (i.e., reconstructed frame pixel values), the content in a frame can be classified into the following class types:
1. static background (SB);
2. moving object (MO);
3. appearing object (AO);
4. disappearing object (DO); and,
5. edges (EDGE).

Thus, the class type of the region of the frame at which the current motion vector is pointing is analyzed and will affect the processing of the frames that are to be interpolated. The introduction of EDGE class to the content classification adds an additional class of content classification and provides an improvement in the FRUC process, as described herein.

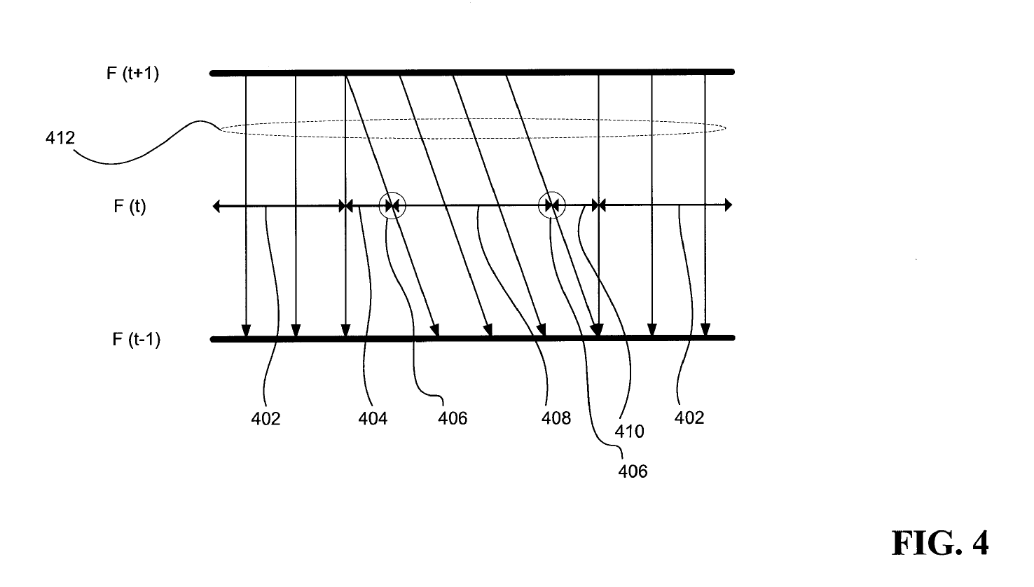

FIG. 4 provides an illustration of the different classes of pixels, including a moving object (MO) 408, an appearing object (AO) 404, a disappearing object (DO) 410, a static background (SB) 402 and an edge 406 classes for MCI, where a set of arrows 412 denotes the motion trajectory of the pixels in the three illustrated frames: F(t−1), F(t) and F(t+1). Specifically, in the context of MCI, each pixel or region inside each video frame can be classified into one of the above-listed five classes and an associated motion vector may be processed in a particular fashion based on a comparison of the change (if any) of class type information. For example, if a motion vector that is pointed at a region that is classified as a static background in the previous reference frame but which changes classification to a moving object in the current frame, the motion vector may be marked as an outlier motion vector. In addition, the above-mentioned five content classifications can be group into three less-restricted classes when the differences between the SB, AO and DO classes are minor:
1. SB 402, AO 404, DO 410;
2. MO 408; and,
3. EDGE 406.

In one embodiment, two different approaches are used to perform the classification of DO 410, SB 402, AO 404 and MO 408 content, each based on different computational complexities. In the low-complexity approach, for example, the following formulas may be used to classify content:
Qc=abs(Fc[yn][xn]−Fp[yn][xn]);
Qp=abs(Fp[yn][xn]−Fpp[yn][xn]);
Qc=(Qc>threshold); and,
Qp=(Qp>threshold);

where:
yn and xn are the y and x coordination positions of the pixel;
Fc is the current frame's pixel value;
Fp is the previous frame's pixel value;
Fpp is the previous-previous frame pixel value;
Qc is the absolute pixel value difference between collocated pixels (located at [yn][xn]) in current- and previous frames; and,
Qp is the absolute pixel value difference between collocated pixels (located at [yn][xn]) in previous- and previous-previous frames; and:
if (Qc && Qp) then classify the object as a moving object;
else if (!Qc && !Qp) then classify the object as a stationary background;
else if (Qc && !Qp) then classify the object as a disappearing object;
else if (!Qc && Qp) the classify the object as an appearing object.

In the high-complexity approach, for example, classification is based on object segmentation and morphological operations, with the content classification being performed by tracing the motion of the segmented object. Thus:
1. perform object segmentation on the motion field;
2. trace the motion of the segmented object (e.g., by morphological operations); and,
3. mark the object as SB, AO, DO, and MO, respectively.

As discussed, the EDGE 406 classification is added to FRUC system 100. Edges characterize boundaries and therefore are of fundamental importance in image processing, especially the edges of moving objects. Edges in images are areas with strong intensity contrasts (i.e., a large change in intensity from one pixel to the next). Edge detection provides the benefit of identification of objects in the picture. There are many ways to perform edge detection. However, the majority of the different methods may be grouped into two categories: gradient and Laplacian. The gradient method detects the edges by looking for the maximum and minimum in the first derivative of the image. The Laplacian method searches for zero crossings in the second derivative of the image to find edges. The techniques of the gradient or Laplacian methods, which are one-dimensional, is applied to two-dimensions by the Sobel method.

$$Gx = \begin{matrix}- 1 & 0 & 1 \\ - 2 & 0 & 2 \\ - 1 & 0 & 1\end{matrix}$$

$$Gy = \begin{matrix}1 & 2 & 1 \\ 0 & 0 & 0 \\ - 1 & - 2 & - 1\end{matrix}$$

$$L = \begin{matrix}- 1 & - 1 & - 1 & - 1 & - 1 \\ - 1 & - 1 & - 1 & - 1 & - 1 \\ - 1 & - 1 & 24 & - 1 & - 1 \\ - 1 & - 1 & - 1 & - 1 & - 1 \\ - 1 & - 1 & - 1 & - 1 & - 1\end{matrix}$$

In one embodiment, where variable block sizes are used, the system performs an oversampling of the motion vectors to the smallest block size. For example, in H.264, the smallest block size for a motion vector is 4×4. Thus, the oversampling function will oversample all the motion vectors of a frame to 4×4. After the oversampling function, a fixed size merging can be applied to the oversampled motion vectors to a predefined block size. For example, sixteen (16) 4×4 motion vectors can be merged into one 16×16 motion vector. The merging function can be an average function or a median function.

A reference frame motion vector extrapolation module 116 provides extrapolation to the reference frame's motion field, and therefore, provides an extra set of motion field information for performing MCI for the frame to be interpolated. Specifically, the extrapolation of a reference frame's motion vector field may be performed in a variety of ways based on different motion models (e.g., linear motion and motion acceleration models). The extrapolated motion field provides an extra set of information for processing the current frame. In one embodiment, this extra information can be used for the following applications:
1. motion vector assignment for the general purpose of video processing, and specifically for FRUC;
2. adaptive bi-directional motion estimation for the general purpose of video processing, and specifically for FRUC;
3. mode decision for the general purpose of video processing; and,
4. motion based object segmentation for the general purpose of video processing.

Thus, the reference frame motion vector extrapolation module 116 extrapolates the reference frame's motion field to provide an extra set of motion field information for MCI of the frame to be encoded. In one embodiment, the FRUC system 100 supports both motion estimation (ME)-assisted and non-ME-assisted variations of MCI, as further discussed below.

The operation of the extrapolation module 116 of the FRUC system 100 will be described first with reference to a single frame, linear motion, model, and then with reference to three variations of a single frame, motion acceleration, model. The operation of the extrapolation module 116 in models with multiple reference frames and with either linear motion or motion acceleration variations will follow.

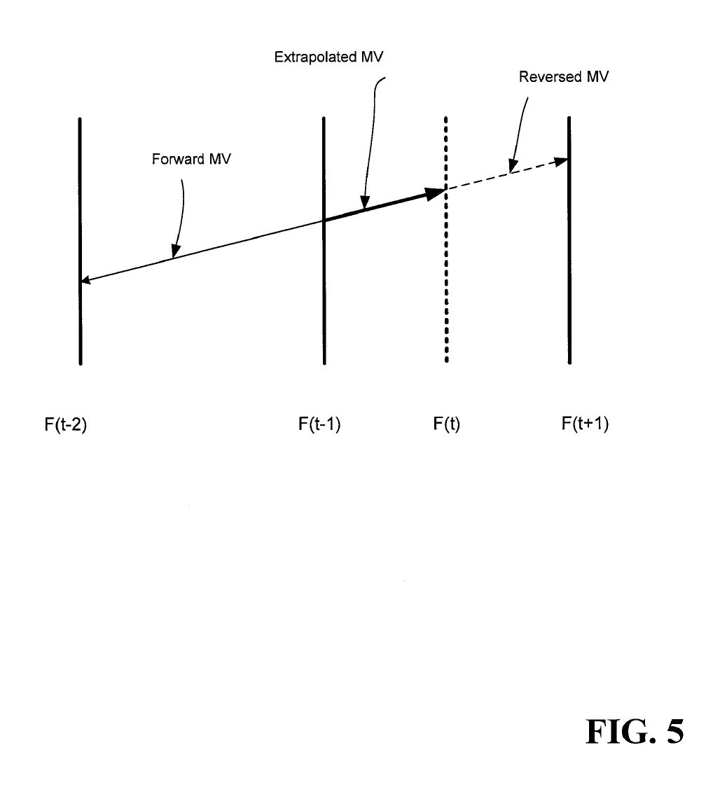

In the single reference frame, linear motion, model, the moving object moves in a linear motion, with constant velocity. An example is illustrated in FIG. 5, where F(t+1) is the current frame, F(t) is the frame-to-be-interpolated (F-frame), F(t−1) is the reference frame, and F(t−2) is the reference frame for F(t−1). In one embodiment, the extrapolation module 116 extracts the motion vector by:
1. reversing the reference frame's motion vector; and,
2. properly scaling the motion vector down based on the time index to the F-frame. In one embodiment, the scaling is linear.

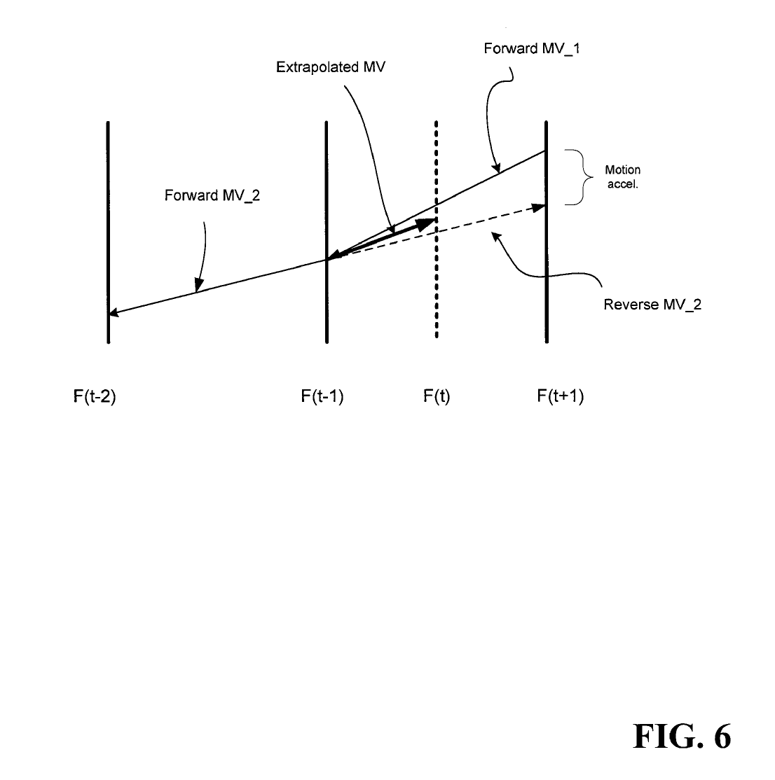

FIG. 6 illustrates the single reference frame, non-linear motion, model motion vector extrapolation, where F(t+1) is the current frame, F(t) is the frame-to-be-interpolated (F-frame), F(t−1) is the reference frame and F(t−2) is the reference frame for F(t−1). In the non-linear motion model, the acceleration may be constant or variable. In one embodiment, the extrapolation module 116 will operate differently based on the variation of these models. Where the acceleration is constant, for example, the extrapolation module 116 will:
1. reverse the reference frame F(t−1)'s motion vector (MV_2);
2. calculate the difference between the current frame F(t+1)'s motion vector (MV_1) and the reversed MV_2, that is, the motion acceleration;
3. properly scale both the reversed MV_2 from step 1 and the motion acceleration obtained from step 2; and,
4. sum up the scaled motion vector and the scaled acceleration to get the extrapolated motion vector.

Where the acceleration is variable, in one approach the extrapolation module 116 will:
1. trace back multiple previous reference frames' motion vectors;
2. calculate the motion trajectory by solving a polynomial/quadratic mathematical function, or by statistical data modeling using least square, for example; and,
3. calculate the extrapolated MV to sit on the calculated motion trajectory.

The extrapolation module 116 can also use a second approach in the single frame, variable acceleration, model:
1. use the constant acceleration model, as describe above, to calculate the acceleration-adjusted forward MV_2 from the motion field of F(t−1), F(t−2) and F(t−3);
2. reverse the acceleration-corrected forward MV_2 to get reversed MV_2; and,
3. perform step 3 and step 4 as described in the single reference frame, non-linear motion, model.

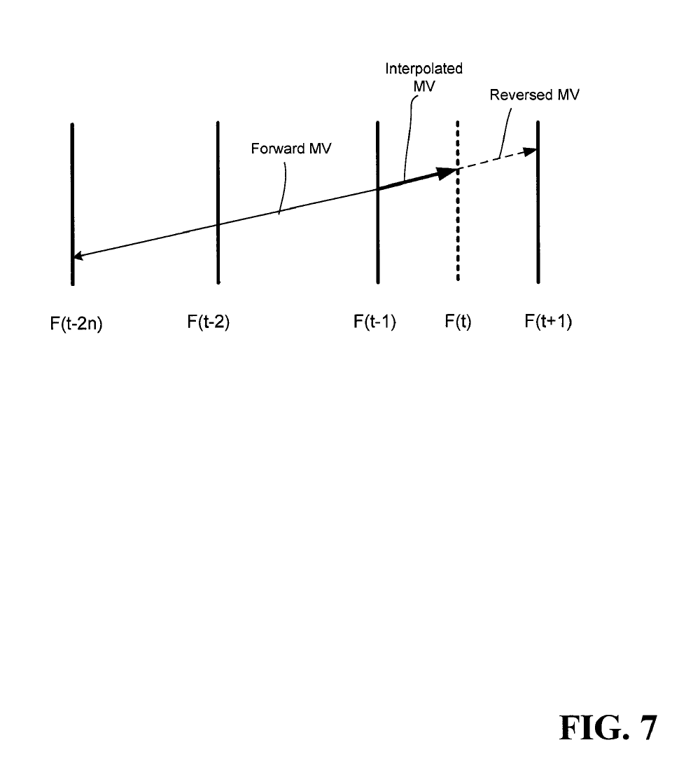

FIG. 7 illustrates the operation of extrapolation module 116 for a multiple reference frame, linear motion, model, where a forward motion vector of a decoded frame may not point to its immediate previous reference frame. However, the motion is still constant velocity. In the figure, F(t+1) is the current frame, F(t) is the frame-to-be-interpolated (F-frame), F(t−1) is the reference frame and F(t−2) is the immediate previous reference frame for F(t−1), while F(t−2n) is a reference frame for frame F(t−1). In this model, the extrapolation module 116 will:
1. reversing the reference frame's motion vector; and,
2. properly scaling it down based on the time index to the F-frame. In one embodiment, the scaling is linear.

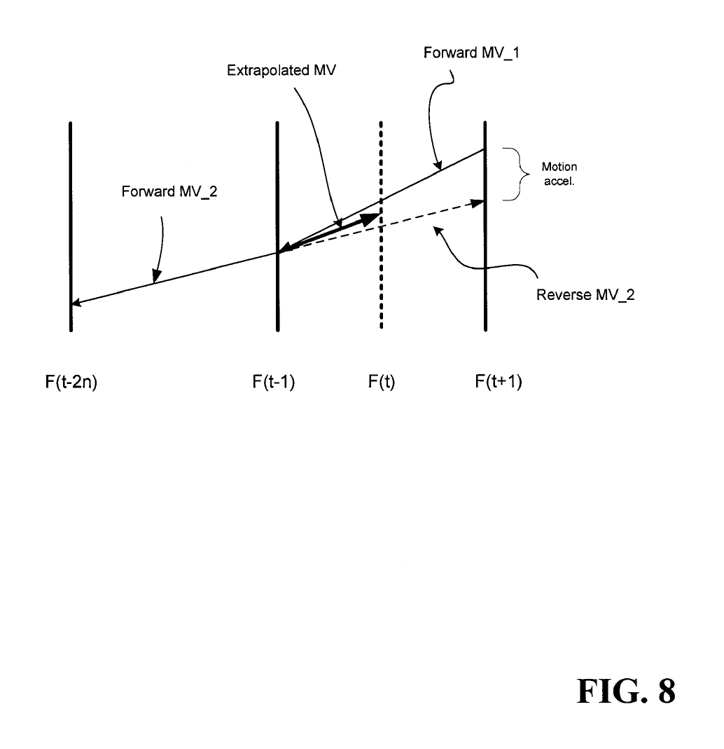

FIG. 8 illustrates a multiple reference frame, non-linear motion, model in which the extrapolation module 116 will perform motion vector extrapolation, where F(t+1) is the current frame, F(t) is the frame-to-be-interpolated (F-frame), F(t−1) is the reference frame and F(t−2) is the immediately previous reference frame for F(t−1), while F(t−2n) is a reference frame for frame F(t−1). In this model, the non-linear velocity motion may be under constant or variable acceleration. In the variation of the non-linear motion model where the object is under constant acceleration, the extrapolation module will extrapolate the motion vector is as follows:
1. reverse the reference frame F(t−2n)'s motion vector (shown as reversed MV_2);
2. calculate the difference between the current frame F(t+1)'s motion vector MV_1 and the reversed MV_2, which is the motion acceleration;
3. properly scale both the reversed MV_2 and the motion acceleration obtained from step 2; and,
4. sum up the scaled reversed MV_2 and the scaled acceleration to get the extrapolated MV.

Where the accelerated motion is not constant, but variable, the extrapolation module will determine the estimated motion vector in one embodiment as follows:
1. trace back the motion vectors of multiple previous reference frames;
2. calculate the motion trajectory by solving a polynomial/quadratic mathematical function or by statistical data modeling (e.g., using a least mean square calculation); and,
3. calculate the extrapolated MV to overlap the calculated motion trajectory.

In another embodiment, the extrapolation module 116 determines the extrapolated motion vector for the variable acceleration model as follows:
1. use the constant acceleration model as describe above to calculate the acceleration-adjusted forward MV_2 from the motion fields of F(t−1), F(t−2) and F(t−3);
2. reverse the acceleration-corrected forward MV_2 to get reversed MV_2; and,
3. repeat step 3 and step 4 as described in the multiple reference, linear motion model.

Once the motion vectors have been extracted, they are sent to a motion vector smoothing module 118. The function of motion vector smoothing module 118 is to remove any outlier motion vectors and reduce the number of artifacts due to the effects of these outliers. One implementation of the operation of the motion vector smoothing module 118 is more specifically described in co-pending patent application Ser. No. 11/122,678 entitled “Method and Apparatus for Motion Compensated Frame Rate up Conversion for Block-Based Low Bit-Rate Video”.

After the motion smoothing module 118 has performed its function, the processing of the FRUC system 100 can change depending on whether or not motion estimation is going to be used, as decided by a decision block 120. If motion estimation will be used, then the process will continue with a F-frame partitioning module 122, which partitions the F-frame into non-overlapped macro blocks. One possible implementation of the partitioning module 122 is found in co-pending patent application Ser. No. 11/122,678 entitled “Method and Apparatus for Motion Compensated Frame Rate up Conversion for Block-Based Low Bit-Rate Video”. The partitioning function of the partitioning module 122 is also used downstream in a block-based decision module 136, which, as further described herein, determines whether the interpolation will be block-based or pixel-based.

After the F-frame has been partitioned into macro blocks, a motion vector assignment module 124 will assign each macro block a motion vector. One possible implementation of the motion vector assignment module 124, which is also used after other modules as shown in FIG. 1, is described in co-pending patent application Ser. No. 11/122,678 entitled “Method and Apparatus for Motion Compensated Frame Rate up Conversion for Block-Based Low Bit-Rate Video”.

Once motion vector assignments have been made to the macro blocks, an adaptive bi-directional motion estimation (Bi-ME) module 126 will be used as a part of performing the motion estimation-assisted FRUC. As further described below, the adaptive bi-directional motion estimation for FRUC performed by Bi-ME module 126 provides the following verification/checking functions:
1. when the seed motion vector is a correct description of the motion field, the forward motion vector and backward motion vector from the bi-directional motion estimation engine should be similar to each other; and,
2. when the seed motion vector is a wrong description of the motion field, the forward motion vector and backward motion vector will be quite different from each other.

Thus, the bi-directional motion compensation operation serves as a blurring operation on the otherwise discontinuous blocks and will provide a more visually pleasant picture.

The importance of color information in the motion estimation process as performed by the Bi-ME module 126 should be noted because the role played by Chroma channels in the FRUC operation is different than the role Chroma channels play in the “traditional” MPEG encoding operations. Specifically, Chroma information is more important in FRUC operations due to the “no residual refinement” aspect of the FRUC operation. For FRUC operation, there is no residual information because the reconstruction process uses the pixels in the reference frame the MV pointed to as the reconstructed pixels in the F-MB; while for normal motion compensated decoding, the bitstream carries both the motion vector information and residual information for chroma channel, even in the case when the motion vector is not very accurate, the residual information carried in the bitstream will compensate the reconstructed value to some extent. Therefore, the correctness of motion vector is more important for FRUC operation. Thus, in one embodiment, Chroma information is included in the process of determining the best-matched seed motion vector by determining:
Total Distortion=W_{—}1*D_{—}Y+W_{—}2*D_{—}U+W_{—}3*D_{—}V
where, D_Y is the distortion metric for the Y (Luminance) channel; D_U (Chroma Channel, U axis) and D_V (Chroma channel, V axis) are the distortion metrics for the U and V Chroma channels, respectively; and, W_1, W_2 and W_3 are the weighting factors for the Y, U, and V channels, respectively. For example, w_1= 4/6; w_2=w_3= 1/6.

Not all macro blocks need full bi-directional motion estimation. In one embodiment, other motion estimation processes such as unidirectional motion estimation may be used as an alternative to bi-directional motion estimation. In general, the decision of whether unidirectional motion estimation or bi-directional motion estimation is sufficient for a given macro block may be based on such factors as the content class of the macro block, and/or the number of motion vectors passing through the macro block.

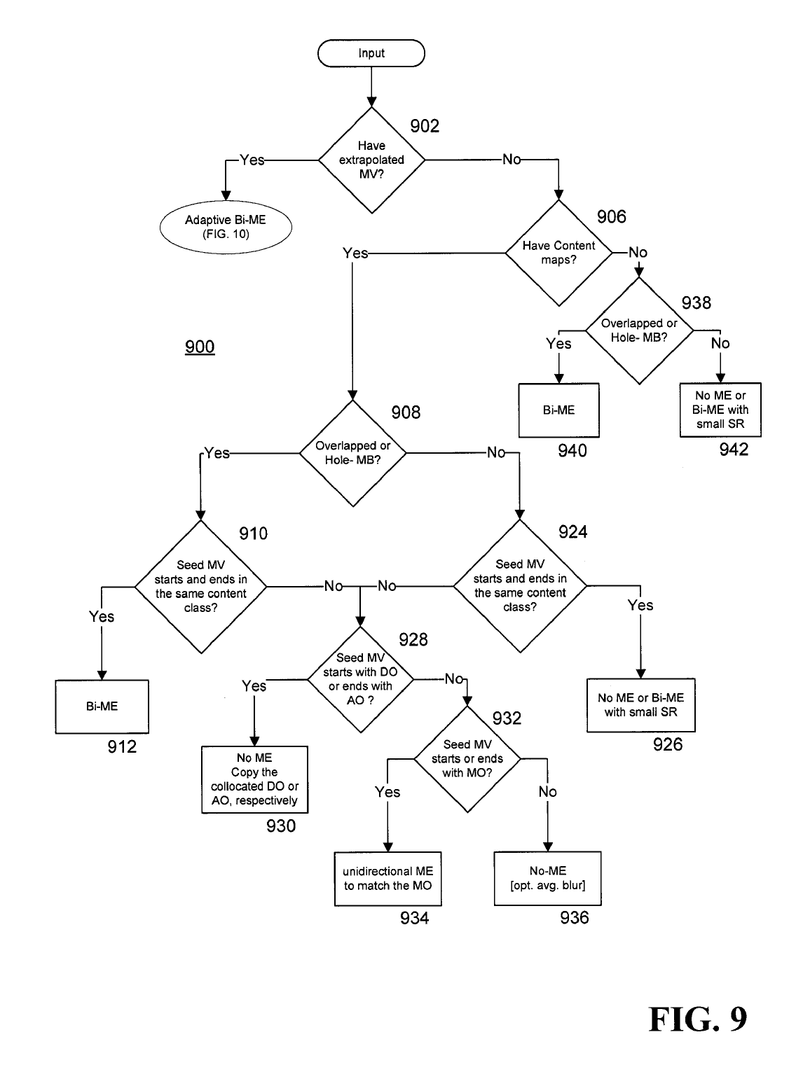

FIG. 9 illustrates a preferred adaptive motion estimation decision process without motion vector extrapolation, i.e., where extrapolated motion vectors do not exist (902), where:
1. If a content map does not exist (906), and the macro block is not an overlapped or hole macro block (938), then no motion estimation is performed (942). Optionally, instead of not performing a motion estimation, a bi-direction motion estimation process is performed using a small search range. For example, a 8×8 search around the center point. If there exists either an overlapped or hole macro block (938), then a bi-directional motion estimation is performed (940);
2. If a content map exists (906), however, and there the macro block is not an overlapped or hole macro block (908), if the seed motion vector starts and ends in the same content class (924), then no motion estimation is performed. Optionally, instead of not performing motion estimation, a bi-directional motion estimation process is performed using a small search range (926). If the seed motion vector does not start and end in the same content class (924), then no motion estimation will be performed (930) if it is detected that the block: (1) from which the seed motion vector starts is classified as a disappearing object (DO); or (2) on which the seed motion vector ends is classified as an appearing object (AO) (928). Instead, the respective collocated DO or AO motion vector will be copied. (930). The same results (930) (i.e., via a “yes” decision at 928) will occur if the macro block is an overlapped or hole macro block (908) and the seed motion vector does not start or end in the same content class (910);
3. If the seed motion vector does not start with a DO content or end with an AO content block (928), but does start or end with a block that is classified to have a moving object (MO) content, then an unidirectional motion estimation is used to create a motion vector that matches the MO (934). Otherwise, either no motion estimation is performed or, optionally, an average blurring operation is performed (936); and,
4. If the seed motion vector starts and ends in the same content class (910), then a bi-directional motion estimation process is used to create the motion vector (912).

However, when extrapolated motion vectors are available, the adaptive motion estimation decision process is different from the process where the extrapolated vectors are not, i.e., when extrapolated motion vectors exist (902):
1. each macroblock has two seed motion vectors: a forward motion vector (F_MV) and a backward motion vector (B_MV);
2. the forward motion estimation is seeded by the forward motion vector; and,
3. the backward motion estimation is seeded by the backward motion vector.

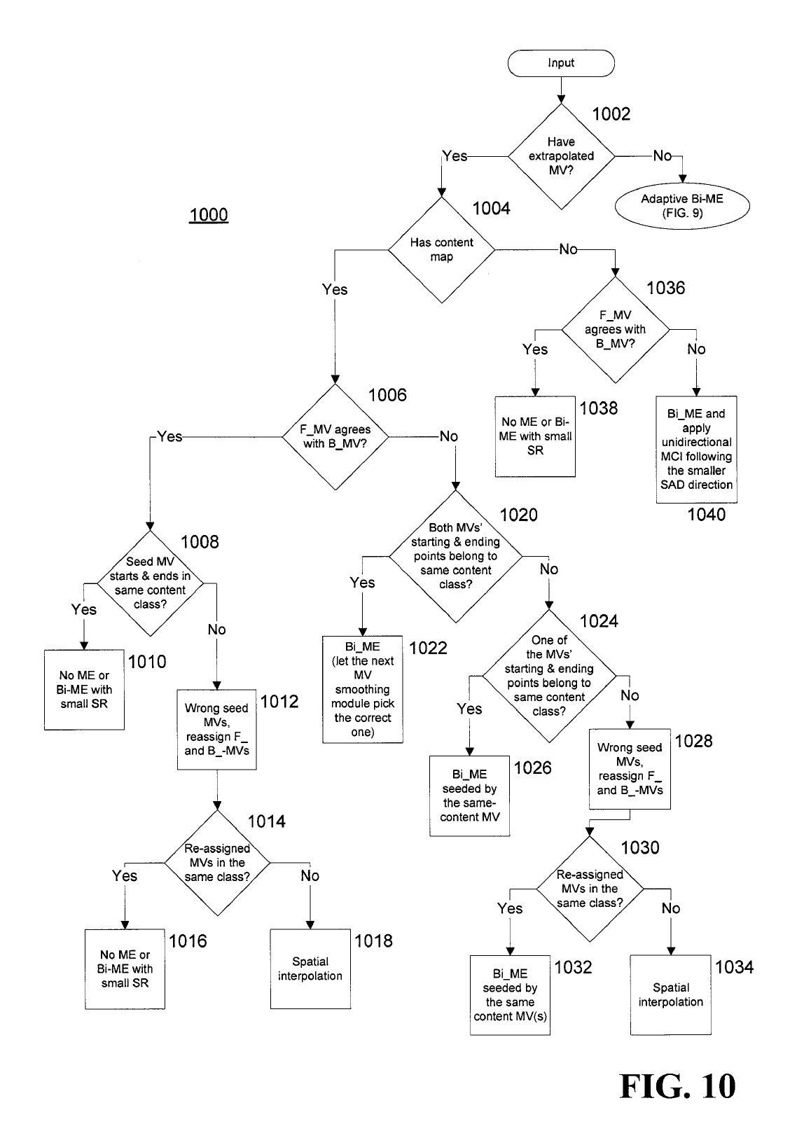

FIG. 10 illustrates a preferred adaptive motion estimation decision process with motion vector extrapolation (1002), where:
1. If a content map exists (1004) and the forward motion vector agrees with the backward motion vector (1006), in one embodiment, no motion estimation will be performed (1010) if the seed motion vectors start and end in the same content class (1008). Specifically, no motion estimation will be performed (1010) if the magnitude and direction, and also the content class of the starting and ending points of the forward motion vector agrees with the backward motion vector. Optionally, instead of not performing motion estimation, a bi-directional motion estimation may be performed using a small search range (1010).
2. If the seed motion vectors do not start and end in the same content class (1008), then it is determined that wrong seed motion vectors have been assigned and a forward motion vector and a backward motion vector are reassigned (1012). If the reassigned motion vectors are in the same content class (1014), then, in one embodiment, no motion estimation will be performed (1016) if the seed motion vectors start and end in the same content class. Optionally, instead of not performing motion estimation, a bi-directional motion estimation may be performed using a small search range (1016). If the reassigned motion vectors do not start and end in the same content class (1014), then spatial interpolation is used (1018);
3. If the forward motion vector does not agree with the backward motion vector (1006), then a bi-directional motion estimation process is performed (1022) if the starting and ending points of both motion vectors belong to the same content class (1022). Otherwise, if one of the motion vectors starting and ending points belong to the same content class (1024), a bi-directional motion estimation will be performed using the motion vector that has starting and ending points in the same content class as a seed motion vector (1026).
4. If neither of the motion vectors have starting and ending points belonging to the same content class (1024), then the forward motion vector and the backward motion vector have to be re-assigned as they are wrong seed motion vectors (1028). if the reassigned motion vectors are in the same class (1030), then a bi-directional motion estimation is performed using the same content class motion vectors (1032). Otherwise, if the starting and ending points of the reassigned motion vectors are not in the same content class (1030), then spatial interpolation is performed (1034); and,
5. If the content map is not available (1004), then no motion estimation is performed (1038) if the forward motion vector and the backward motion vectors agree with each other (1036). Optionally, instead of not performing motion estimation, bi-motion estimation with a small search range may be performed (1038). Otherwise, if the forward and backward motion vectors do not agree (1036), then a bi-directional motion estimation will be performed (1040) applying an unidirectional motion compensation interpolation that follows the direction of the smaller sum of absolute differences (SAD).

After the adaptive bi-directional motion estimation process has been performed by Bi-ME module 126, each macro block will have two motion vectors—a forward motion vector and backward motion vector. Motion vector smoothing 128 may be performed at this point. Given these two motion vectors, in one embodiment there are three possible modes in which the FRUC system 100 can perform MCI to construct the F-frame. A mode decision module 130 will determine if the FRUC system 100 will:
1. use both the motion vectors and perform a bi-directional motion compensation interpolation (Bi-MCI);
2. use only the forward motion vector and perform a unidirectional motion compensation; and,
3. use only the backward motion vector and perform a unidirectional motion compensation.

Performing the mode decision is a process of intelligently determining which motion vector(s) describe the true motion trajectory, and choosing a motion compensation mode from the three candidates described above. For example, where the video stream contains talk shows or other human face rich video sequences, skin-tone color segmentation is a useful technique that may be utilized in the mode decision process. Color provides unique information for fast detection. Specifically, by focusing efforts on only those regions with the same color as the target object, search time may be significantly reduced. Algorithms exist for locating human faces within color images by searching for skin-tone pixels. Morphology and median filters are used to group the skin-tone pixels into skin-tone blobs and remove the scattered background noise. Typically, skin tones are distributed over a very small area in the chrominance plane. The human skin-tone is such that in the Chroma domain, 0.3<Cb<0.5 and 0.5<Cr<0.7 after normalization, where Cb and Cr are the blue and red components of the Chroma channel, respectively.

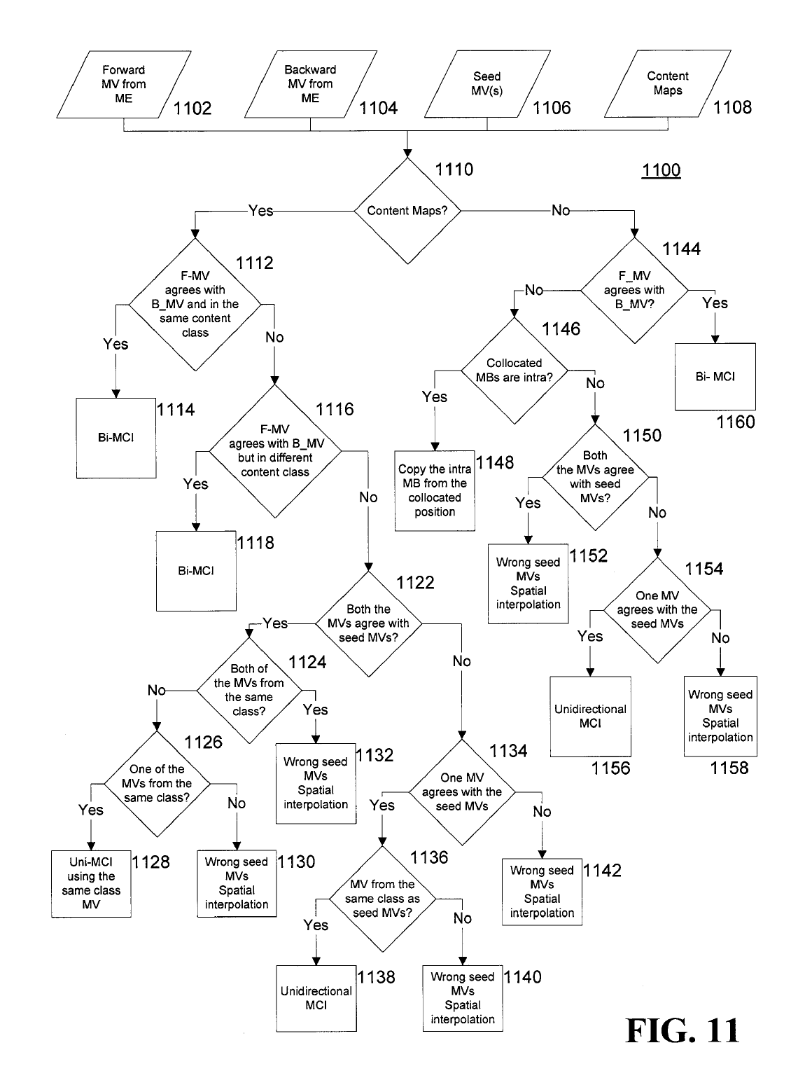

FIG. 11 illustrates a mode decision process 1100 used by the mode decision module 130 for the FRUC system 100, where given a forward motion vector (Forward MV) 1102 and a backward motion vector (Backward MV) 1104 from the motion estimation process described above, seed motion vectors (Seed MV(s)) 1106, and a content map 1108 as potential inputs:
1. Bi-MCI will be performed (1114) if there are content maps (1110) and if the forward and backward motion vectors agree with each other, and their starting and ending points are in the same content class (1112). In addition, Bi-MCI will be performed (1118) if the forward motion vector agrees with the backward motion vector but have ending points in different content classes (1116). In this latter case, although wrong results may arise due to the different content classes, these possible wrong results should be corrected after the motion vector smoothing process;
2. If the forward and backward motion vectors do not agree with each other (1116) but each of the motion vectors agree with their respective seed motion vectors (1122), then spatial interpolation will be performed (1132) if it is determined that both of the seed motion vectors are from the same class (1124), where a motion vector from the same class means both the starting and ending points belong to one class. Otherwise, if both of the motion vectors are from different content classes (1124), but one of the motion vectors is from the same class (1126) (e.g., where the same class refers to the starting and ending points of the seed motion vector being in the same content class), then an unidirectional MCI will be performed using that motion vector (1128). If neither of the motion vectors are from the same class (1126), then spatial interpolation will be performed (1130).
3. If both motion vectors do not agree with both seed motion vectors (1122), but one of the motion vectors agrees with at least one of the seed motion vectors (1134), then an unidirectional MCI will be performed (1138) if the motion vector is from the same class as the seed motion vectors (1136). Otherwise, spatial interpolation will be performed (1140, 1142) if neither of the motion vectors agree with the seed motion vectors (1134) or if the one motion vector that agrees with the seed motion vectors is not from the same class as the seed motion vectors (1136), respectively.
4. A Bi-MCI operation is also performed (1160) if there are no content maps (1110) but the forward motion vector agrees with the backward motion vector (1144). Otherwise, if the forward and backward motion vectors do not agree (1144) but the collocated macroblocks are intraframe (1146), then the intraframe macro block that is at the collocated position with the motion vectors is copied (1148). If the motion vectors are not reliable and the collocated macroblock is an intra-macroblock (which implies a new object), then it is very reasonable to assume that the current macroblock is the part of the new object at this time instance, and the copy of the collocated macroblock is a natural step. Otherwise, if the collocated macro blocks are not in the intraframe (1146) and both the motion vectors agree with the seed motion vectors (1150), then a spatial interpolation will be performed as the seed motion vectors are incorrect (1152).
5. If both motion vectors do not agree with both seed motion vectors (1150), but one of the motion vectors agrees with at least one of the seed motion vectors (1154), then a unidirectional MCI is performed (1156). Otherwise, if neither of the motion vectors agree with the seed motion vectors, then a spatial interpolation will be performed as the seed motion vectors are wrong (1158).

The Bi-MCI and macroblock reconstruction module 132 is described in co-pending patent application Ser. No. 11/122,678 entitled “Method and Apparatus for Motion Compensated Frame Rate up Conversion for Block-Based Low Bit-Rate Video.”

After the macro blocks are reassembled to construct the F-frame, a deblocker 134 is used to reduce artifacts created during the reassembly. Specifically, the deblocker 134 smoothes the jagged and blocky artifacts located along on the boundaries between the macro blocks.

Referring back to FIG. 1, after the motion smoothing module 118 has performed its function, the processing of the FRUC system 100 can change depending on whether or not motion estimation is going to be used, as decided by a decision block 120. If motion estimation will not be used, then the process will continue with block-based decision module 136, which determines whether the interpolation will be block-based or pixel-based. If the interpolation will be block based, per decision module 136, then the process will continue with an F-frame partitioning module 122, which partitions the F-frame into non-overlapped macro blocks, as previously discussed. One possible implementation of the partitioning module 122 is found in co-pending patent application Ser. No. 11/122,678 entitled “Method and Apparatus for Motion Compensated Frame Rate up Conversion for Block-Based Low Bit-Rate Video”.

After the F-frame has been partitioned into macro blocks 122, a motion vector assignment module 124 will assign each macro block a motion vector, as previously discussed. One possible implementation of the motion vector assignment module 124, which is also used after other modules as shown in FIG. 1, is described in co-pending patent application Ser. No. 11/122,678 entitled “Method and Apparatus for Motion Compensated Frame Rate up Conversion for Block-Based Low Bit-Rate Video”. Motion vector smoothing 128, as previously discussed, may be performed at this point, followed by Bi-MCI and macroblock reconstruction module 132, as previously discussed, which is described in co-pending patent application Ser. No. 11/122,678 entitled “Method and Apparatus for Motion Compensated Frame Rate up Conversion for Block-Based Low Bit-Rate Video.” After the macro blocks are reassembled to construct the F-frame, a deblocker 134 is used to reduce artifacts created during the reassembly, as has been previously discussed. Specifically, the deblocker 134 smoothes the jagged and blocky artifacts located along on the boundaries between the macro blocks.

If the interpolation, subsequent to block-based decision module 136, will not be block based (i.e., it will be pixel based), then the process will continue with motion vector assignment to all pixels that have motion vectors passing through them 138. After motion vector assignment 128, Bi-MCI and macroblock reconstruction module 132, as previously discussed, will be performed if there is one motion vector per pixel 140. If there is no motion vector per pixel 142, then motion vector assignment to hole-pixels will be performed 144, followed by Bi-MCI and macroblock reconstruction module 132, as previously discussed. If there are multiple motion vectors per pixel 142 (i.e., not one motion vector per pixel 140 and not no motion vectors 142), then motion vector assignment to overlapped pixels will be performed 146, followed by Bi-MCI and macroblock reconstruction module 132, as previously discussed.

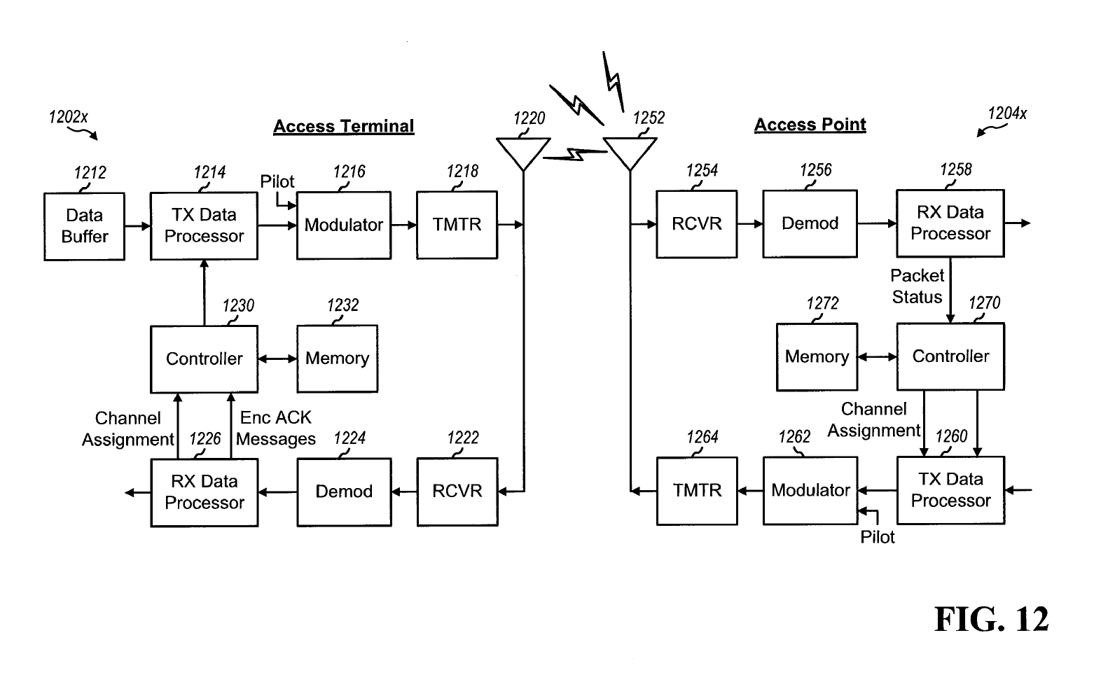

FIG. 12 shows a block diagram of an access terminal 1202x and an access point 1204x in a wireless system on which the FRUC approach described herein may be implemented. An “access terminal,” as discussed herein, refers to a device providing voice and/or data connectivity to a user. The access terminal may be connected to a computing device such as a laptop computer or desktop computer, or it may be a self contained device such as a personal digital assistant. The access terminal can also be referred to as a subscriber unit, mobile station, mobile, remote station, remote terminal, user terminal, user agent, or user equipment. The access terminal may be a subscriber station, wireless device, cellular telephone, PCS telephone, a cordless telephone, a Session Initiation Protocol (SIP) phone, a wireless local loop (WLL) station, a personal digital assistant (PDA), a handheld device having wireless connection capability, or other processing device connected to a wireless modem. An “access point,” as discussed herein, can also refer to a device in an access network that communicates over the air-interface, through one or more sectors, with the access terminals. The access point acts as a router between the access terminal and the rest of the access network, which may include an IP network, by converting received air-interface frames to IP packets. The access point also coordinates the management of attributes for the air interface.

For the reverse link, at access terminal 1202x, a transmit (TX) data processor 1214 receives traffic data from a data buffer 1212, processes (e.g., encodes, interleaves, and symbol maps) each data packet based on a selected coding and modulation scheme, and provides data symbols. A data symbol is a modulation symbol for data, and a pilot symbol is a modulation symbol for pilot (which is known a priori). A modulator 1216 receives the data symbols, pilot symbols, and possibly signaling for the reverse link, performs (e.g., OFDM) modulation and/or other processing as specified by the system, and provides a stream of output chips. A transmitter unit (TMTR) 1218 processes (e.g., converts to analog, filters, amplifies, and frequency upconverts) the output chip stream and generates a modulated signal, which is transmitted from an antenna 1220.

At access point 1204x, the modulated signals transmitted by access terminal 1202x and other terminals in communication with access point 1204x are received by an antenna 1252. A receiver unit (RCVR) 1254 processes (e.g., conditions and digitizes) the received signal from antenna 1252 and provides received samples. A demodulator (Demod) 1256 processes (e.g., demodulates and detects) the received samples and provides detected data symbols, which are noisy estimate of the data symbols transmitted by the terminals to access point 1204x. A receive (RX) data processor 1258 processes (e.g., symbol demaps, deinterleaves, and decodes) the detected data symbols for each terminal and provides decoded data for that terminal.

For the forward link, at access point 1204x, traffic data is processed by a TX data processor 1260 to generate data symbols. A modulator 1262 receives the data symbols, pilot symbols, and signaling for the forward link, performs (e.g., OFDM) modulation and/or other pertinent processing, and provides an output chip stream, which is further conditioned by a transmitter unit 1264 and transmitted from antenna 1252. The forward link signaling may include power control commands generated by a controller 1270 for all terminals transmitting on the reverse link to access point 1204x. At access terminal 1202x, the modulated signal transmitted by access point 1204x is received by antenna 1220, conditioned and digitized by a receiver unit 1222, and processed by a demodulator 1224 to obtain detected data symbols. An RX data processor 1226 processes the detected data symbols and provides decoded data for the terminal and the forward link signaling. Controller 1230 receives the power control commands, and controls data transmission and transmit power on the reverse link to access point 1204x. Controllers 1230 and 1270 direct the operation of access terminal 1202x and access point 1204x, respectively. Memory units 1232 and 1272 store program codes and data used by controllers 1230 and 1270, respectively.

The disclosed embodiments may be applied to any one or combinations of the following technologies: Code Division Multiple Access (CDMA) systems, Multiple-Carrier CDMA (MC-CDMA), Wideband CDMA (W-CDMA), High-Speed Downlink Packet Access (HSDPA), Time Division Multiple Access (TDMA) systems, Frequency Division Multiple Access (FDMA) systems, and Orthogonal Frequency Division Multiple Access (OFDMA) systems.

It should be noted that the methods described herein may be implemented on a variety of communication hardware, processors and systems known by one of ordinary skill in the art. For example, the general requirement for the client to operate as described herein is that the client has a display to display content and information, a processor to control the operation of the client and a memory for storing data and programs related to the operation of the client. In one embodiment, the client is a cellular phone. In another embodiment, the client is a handheld computer having communications capabilities. In yet another embodiment, the client is a personal computer having communications capabilities. In addition, hardware such as a GPS receiver may be incorporated as necessary in the client to implement the various embodiments. The various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium is coupled to the processor, such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The embodiments described above are exemplary embodiments. Those skilled in the art may now make numerous uses of, and departures from, the above-described embodiments without departing from the inventive concepts disclosed herein. Various modifications to these embodiments may be readily apparent to those skilled in the art, and the generic principles defined herein may be applied to other embodiments, e.g., in an instant messaging service or any general wireless data communication applications, without departing from the spirit or scope of the novel aspects described herein. Thus, the scope of the embodiments is not intended to be limited to the embodiments shown herein but is to be accorded the widest scope consistent with the principles and novel features disclosed herein. The word “exemplary” is used exclusively herein to mean “serving as an example, instance, or illustration.” Any embodiment described herein as “exemplary” is not necessarily to be construed as preferred or advantageous over other embodiments. Accordingly, the novel aspects of the embodiments described herein is to be defined solely by the scope of the following claims.

What is claimed is:

1. A method for creating an interpolated video frame using a current video frame and a plurality of previous video frames, the method comprising:
creating a set of extrapolated motion vectors from at least one reference video frame in the plurality of previous video frames;
performing an adaptive motion estimation using the extrapolated motion vectors and a class type of each extrapolated motion vector;
deciding on a motion compensated interpolation mode; and
creating a set of motion compensated motion vectors based on the motion compensated interpolation mode decision.

2. The method of claim 1, wherein the class type is selected from a list of class types, the list of class types including: static background, moving object, appearing object, disappearing object, edge, and outlier.

3. The method of claim 1, further comprising smoothing the set of extrapolated motion vectors.

4. The method of claim 1, further comprising creating the interpolated frame based on the set of motion compensated motion vectors.

5. The method of claim 1, wherein the at least one reference video frame includes a plurality of moving objects, each moving object being associated with a respective forward motion vector, and wherein creating the set of extrapolated motion vectors comprises, for each moving object:
creating a reversed motion vector; and
scaling the reversed motion vector.

6. The method of claim 5, wherein creating the reversed motion vector comprises reversing the respective forward vector.

7. The method of claim 5, wherein creating the reversed motion vector comprises:
tracing back a series of motion vectors in the plurality of video frames associated with the moving object;
determining a motion trajectory based on the series of motion vectors; and
calculating a trajectory of the reversed motion vector to sit on the determined motion trajectory.

8. The method of claim 5, wherein the reversed motion vector is scaled based on a time index of the at least one reference frame.

9. The method of claim 5, wherein scaling the reversed motion vector comprises:
determining an amount of motion acceleration by calculating a difference between a current video frame forward motion vector and the reversed motion vector;
scaling both the reversed motion vector and the amount of motion acceleration; and
combining the reversed motion vector and the amount of motion acceleration.

10. The method of claim 1, wherein performing the motion compensated interpolation mode decision comprises:
determining at least one motion vector that describe a true motion trajectory of an object; and
performing a motion compensated interpolation.

11. The method of claim 10, wherein the at least one motion vector includes a forward motion vector and a backward motion vector, and performing the motion compensated interpolation comprises performing a bi-directional motion compensated interpolation using both the forward motion vector and the backward motion vector.

12. The method of claim 10, wherein performing the motion compensated interpolation comprises performing a unidirectional motion compensation interpolation.

13. The method of claim 10, wherein the at least one motion vector includes a forward motion vector and the unidirectional motion compensated interpolation is performed using the forward motion vector.

14. The method of claim 10, wherein the at least one motion vector includes a backward motion vector and the unidirectional motion compensated interpolation is performed using the backward motion vector.

15. An apparatus for creating an interpolated video frame using a current video frame and a plurality of previous video frames, the apparatus comprising:
means for creating a set of extrapolated motion vectors from at least one reference video frame in the plurality of previous video frames;
means for performing an adaptive motion estimation using the extrapolated motion vectors and a class type of each extrapolated motion vector;
means for deciding on a motion compensated interpolation mode; and
means for creating a set of motion compensated motion vectors based on the motion compensated interpolation mode decision.

16. The apparatus of claim 15, wherein the class type is selected from a list of class types, the list of class types including: static background, moving object, appearing object, disappearing object, edge, and outlier.

17. The apparatus of claim 15, further comprising means for smoothing the set of extrapolated motion vectors.

18. The apparatus of claim 15, further comprising means for creating the interpolated frame based on the set of motion compensated motion vectors.

19. The apparatus of claim 15, wherein the at least one reference video frame includes a plurality of moving objects, each moving object being associated with a respective forward motion vector, and wherein the means for creating the set of extrapolated motion vectors comprises, for each moving object:
means for creating a reversed motion vector; and
means for scaling the reversed motion vector.

20. The apparatus of claim 19, wherein the means for creating the reversed motion vector comprises reversing the respective forward vector.

21. The apparatus of claim 19, wherein the means for creating the reversed motion vector comprises:
means for tracing back a series of motion vectors in the plurality of video frames associated with the moving object;
means for determining a motion trajectory based on the series of motion vectors; and
means for calculating a trajectory of the reversed motion vector to sit on the determined motion trajectory.

22. The apparatus of claim 19, wherein the reversed motion vector is scaled based on a time index of the at least one reference frame.

23. The apparatus of claim 19, wherein the means for scaling the reversed motion vector comprises:
means for determining an amount of motion acceleration by calculating a difference between a current video frame forward motion vector and the reversed motion vector;
means for scaling both the reversed motion vector and the amount of motion acceleration; and
means for combining the reversed motion vector and the amount of motion acceleration.

24. The apparatus of claim 15, wherein the means for performing the motion compensated interpolation mode decision comprises:
means for determining at least one motion vector that describe a true motion trajectory of an object; and
means for performing a motion compensated interpolation.

25. The apparatus of claim 24, wherein the at least one motion vector includes a forward motion vector and a backward motion vector, and the means for performing the motion compensated interpolation comprises means for performing a bi-directional motion compensated interpolation using both the forward motion vector and the backward motion vector.

26. The apparatus of claim 24, wherein the means for performing the motion compensated interpolation comprises performing a unidirectional motion compensation interpolation.

27. The apparatus of claim 24, wherein the at least one motion vector includes a forward motion vector and the unidirectional motion compensated interpolation is performed using the forward motion vector.

28. The apparatus of claim 24, wherein the at least one motion vector includes a backward motion vector and the unidirectional motion compensated interpolation is performed using the backward motion vector.

29. A machine readable medium having instructions stored thereon, the stored instructions including one or more segments of code and being executable on one or more machines, the one or more segments of code comprising:
code for creating a set of extrapolated motion vectors from at least one reference video frame in the plurality of previous video frames;
code for performing an adaptive motion estimation using the extrapolated motion vectors and a class type of each extrapolated motion vector;
code for deciding on a motion compensated interpolation mode; and,
code for creating a set of motion compensated motion vectors based on the motion compensated interpolation mode decision.

30. The method of claim 29, wherein the class type is selected from a list of class types, the list of class types including: static background, moving object, appearing object, disappearing object, edge, and outlier.

31. The machine readable medium of claim 29, further comprising code for smoothing the set of extrapolated motion vectors.

32. The machine readable medium of claim 29, further comprising code for creating the interpolated frame based on the set of motion compensated motion vectors.

33. The machine readable medium of claim 29, wherein the at least one reference video frame includes a plurality of moving objects, each moving object being associated with a respective forward motion vector, and wherein the code for creating the set of extrapolated motion vectors comprises, for each moving object:
code for creating a reversed motion vector; and
code for scaling the reversed motion vector.

34. The machine readable medium of claim 33, wherein the code for creating the reversed motion vector comprises code for reversing the respective forward vector.

35. The machine readable medium of claim 33, wherein the code for creating the reversed motion vector comprises:
code for tracing back a series of motion vectors in the plurality of video frames associated with the moving object;
code for determining a motion trajectory based on the series of motion vectors; and
code for calculating a trajectory of the reversed motion vector to sit on the determined motion trajectory.

36. The machine readable medium of claim 33, wherein the reversed motion vector is scaled based on a time index of the at least one reference frame.

37. The machine readable medium of claim 33, wherein the code for scaling the reversed motion vector comprises:
code for determining an amount of motion acceleration by calculating a difference between a current video frame forward motion vector and the reversed motion vector;
code for scaling both the reversed motion vector and the amount of motion acceleration; and
code for combining the reversed motion vector and the amount of motion acceleration.

38. The machine readable medium of claim 29, wherein the code for performing the motion compensated interpolation mode decision comprises:
code for determining at least one motion vector that describe a true motion trajectory of an object; and
code for performing a motion compensated interpolation.

39. The machine readable medium of claim 38, wherein the at least one motion vector includes a forward motion vector and a backward motion vector, and the code for performing the motion compensated interpolation comprises code for performing a bi-directional motion compensated interpolation using both the forward motion vector and the backward motion vector.

40. The machine readable medium of claim 38, wherein the code for performing the motion compensated interpolation comprises code for performing a unidirectional motion compensation interpolation.

41. The machine readable medium of claim 38, wherein the at least one motion vector includes a forward motion vector and the unidirectional motion compensated interpolation is performed using the forward motion vector.

42. The machine readable medium of claim 38, wherein the at least one motion vector includes a backward motion vector and the unidirectional motion compensated interpolation is performed using the backward motion vector.

43. An apparatus for creating an interpolated video frame using a current video frame and a plurality of previous video frames, the apparatus comprising:
a memory; and
a processor, the processor coupled to the memory and configured to:
create a set of extrapolated motion vectors from at least one reference video frame in the plurality of previous video frames;
perform an adaptive motion estimation using the extrapolated motion vectors and a class type of each extrapolated motion vector;
decide on a motion compensated interpolation mode; and
create a set of motion compensated motion vectors based on the motion compensated interpolation mode decision.

44. The method of claim 43, wherein the class type is selected from a list of class types, the list of class types including: static background, moving object, appearing object, disappearing object, edge, and outlier.

45. The apparatus of claim 43, wherein the processor is further configured to smooth the set of extrapolated motion vectors.

46. The apparatus of claim 43, wherein the processor is further configured to create the interpolated frame based on the set of motion compensated motion vectors.

47. The apparatus of claim 43, wherein the at least one reference video frame includes a plurality of moving objects, each moving object being associated with a respective forward motion vector, and wherein the processor, being configured to create the set of extrapolated motion vectors comprises, includes being configured to, for each moving object:
create a reversed motion vector; and
scale the reversed motion vector.

48. The apparatus of claim 47, wherein the processor, being configured to create the reversed motion vector, includes being configured to reverse the respective forward vector.

49. The apparatus of claim 47, wherein the processor, being configured to create the reversed motion vector, includes being configured to:
trace back a series of motion vectors in the plurality of video frames associated with the moving object;
determine a motion trajectory based on the series of motion vectors; and
calculate a trajectory of the reversed motion vector to sit on the determined motion trajectory.

50. The apparatus of claim 47, wherein the reversed motion vector is scaled based on a time index of the at least one reference frame.

51. The apparatus of claim 47, wherein the processor, being configured to scale the reversed motion vector, includes being configured to:
determine an amount of motion acceleration by calculating a difference between a current video frame forward motion vector and the reversed motion vector;
scale both the reversed motion vector and the amount of motion acceleration; and
combine the reversed motion vector and the amount of motion acceleration.

52. The apparatus of claim 43, wherein the processor, being configured to perform the motion compensated interpolation mode decision, includes being configured to:
determine at least one motion vector that describe a true motion trajectory of an object; and
perform a motion compensated interpolation.

53. The apparatus of claim 52, wherein the at least one motion vector includes a forward motion vector and a backward motion vector, and the processor, being configured to perform the motion compensated interpolation, includes being configured to perform a bi-directional motion compensated interpolation using both the forward motion vector and the backward motion vector.

54. The apparatus of claim 52, wherein the processor, being configured to perform the motion compensated interpolation, includes being configured to perform a unidirectional motion compensation interpolation.

55. The apparatus of claim 52, wherein the at least one motion vector includes a forward motion vector and the unidirectional motion compensated interpolation is performed using the forward motion vector.

56. The apparatus of claim 52, wherein the at least one motion vector includes a backward motion vector and the unidirectional motion compensated interpolation is performed using the backward motion vector.
